(19) United States
(12) Patent Application Publication
(10) Pub. No.: US 2020/0016988 A1
(43) Pub. Date: Jan. 16, 2020

(54) BATTERY MODULE FOR A MOTOR VEHICLE

(71) Applicant: Dr. Ing. h.c. F. Porsche Aktiengesellschaft, Stuttgart (DE)

(72) Inventor: Philipp Kellner, Rennigen (DE)

(73) Assignee: Dr. Ing. h.c. F. Porsche Aktiengesellschaft, Stuttgart (DE)

(21) Appl. No.: 16/447,276

(22) Filed: Jun. 20, 2019

(30) Foreign Application Priority Data
Jul. 13, 2018 (DE) 102018117068.8

(51) Int. Cl. B60L 50/64; H01M 2/10

(52) U.S. Cl. CPC B60L 50/64; H01M 2220/20; H01M 2/1077

(57) ABSTRACT

A battery module for a motor vehicle includes a battery module housing and at least one battery cell package. The battery cell package is fitted in a mounting direction into the battery module housing. The battery module housing encloses the battery cell package on four sides, and includes, on at least one of the other two sides, an opening through which the battery cell package is fitted in the mounting direction into the battery module housing. The battery module includes an insertion and positioning aid which serves for inserting the battery cell package in the mounting direction and for positioning the battery cell package in the opening before the insertion of the battery cell package into the battery module housing and includes at least one runner which extends substantially in the mounting direction.

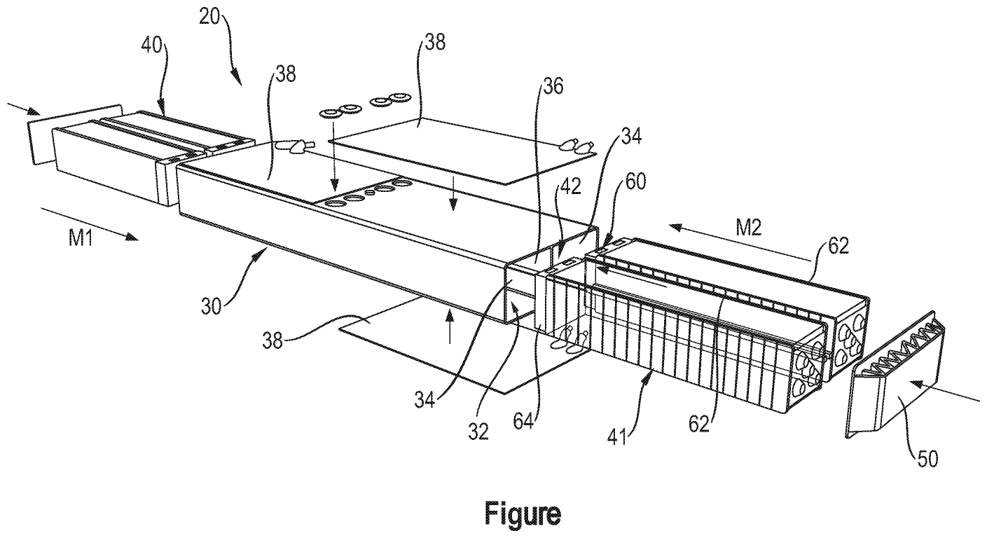

### CROSS-REFERENCE TO RELATED APPLICATION

This application claims priority to German Patent application No. DE 10 2018 117 068.8, filed Jul. 13, 2018, which is incorporated by reference herein in its entirety.

### FIELD OF THE INVENTION

The invention relates to a battery module for a motor vehicle. The battery module can be a battery module of a motor vehicle battery, in particular of a motor vehicle traction battery.

### BACKGROUND OF THE INVENTION

The prior art has disclosed battery modules which comprise a battery module housing and a multiplicity of battery cells which are connected electrically to one another and are arranged in the form of a battery cell package inside the battery module housing.

The battery cells can be prestressed by means of metallic tightening straps before they are introduced into the battery module housing, and said battery cells can be subsequently connected electrically to one another inside the battery module housing. By means of this design, the cooling of the battery cells is made more difficult and the installation space required by the battery module and the manufacturing costs are increased.

### SUMMARY OF THE INVENTION

Described herein is a battery module which has low manufacturing costs, requires little installation space and has a reduced weight.

The battery module according to aspects of the invention comprises a battery module housing and at least one battery cell package. The battery cell package is fitted in a mounting direction into the battery module housing and comprises at least two battery cells which are connected electrically in series. The battery module housing encloses the battery cell package on four sides, and comprises, on at least one of the other two sides, an opening through which the battery cell package is fitted in the mounting direction into the battery module housing. The battery module comprises an insertion and positioning aid which serves for inserting the battery cell package in the mounting direction and for positioning the battery cell package in the opening before the insertion of the battery cell package into the battery module housing. The insertion and positioning aid comprises at least one runner which extends essentially in the mounting direction.

By means of this embodiment and, in particular, by means of the battery module housing which encloses four sides of the battery cell package a battery module is made available which has low manufacturing costs, requires little installation space and has a reduced weight.

The runner can be manufactured in the form of a plastic strap.

The battery cells are preferably connected electrically in the interior of the battery cell package before the insertion of the battery cell package into the battery module housing.

In one preferred embodiment, a gap, which is filled with a heat-conducting medium in order to control the temperature of the battery cells, is formed between the battery cell package and the battery module housing and/or between the battery cells. In this context, the gap can be made as small as possible in order to permit efficient temperature control of the battery cells.

The battery module preferably comprises at least one head plate which serves to close off the opening after the insertion of the battery cell package.

In one preferred embodiment, the insertion and positioning aid comprises at least one component which is arranged at an end, to be inserted firstly into the opening in the mounting direction, of the battery cell package.

The component preferably has a height which is less than or equal to a height of the opening.

In one preferred embodiment, the component has a width which is less than or equal to a width of the opening.

The component preferably has a height which is greater than or equal to a height of the battery cell package.

In one preferred embodiment, the component has a width which is greater than or equal to a width of the battery cell package.

The component preferably comprises an insertion slope and/or a chamfer and/or a radius for centering the battery cell package in the opening.

In one preferred embodiment, the component is fabricated at least essentially from plastic.

The battery module also preferably comprises at least two battery cell packages, wherein each of the battery cell packages is provided with the component, wherein the component is provided with an electrical high-voltage connecting device which produces an electrical connection to the component of an adjacent battery cell package.

In one preferred embodiment, the component serves to protect the electrical high-voltage connecting device.

The runner is preferably attached to the component.

In one preferred embodiment, the insertion and positioning aid comprises a groove which extends essentially parallel to the mounting direction and by means of which the runner slides and is guided when the battery cell package is inserted in the mounting direction into the opening.

The runner is preferably fabricated essentially from plastic.

In one preferred embodiment, the insertion and positioning aid comprises at least two runners which are arranged on opposite sides of the battery cell package or on opposite sides of the battery module housing.

The insertion and positioning aid preferably comprises at least four runners which are arranged in pairs on opposite sides of the battery cell package or on opposite sides of the battery module housing.

In one preferred embodiment the battery module comprises at least two battery cell packages, specifically a first battery cell package and a second battery cell package, wherein the battery module housing comprises at least two openings, wherein the first battery cell package is fitted into the battery module housing in a first mounting direction through one of the openings, wherein the second battery cell package is fitted into the battery module housing in a second mounting direction through the other opening, and wherein the second mounting direction runs opposite the first mounting direction.

Details and further advantages of the battery module according to aspects of the invention are explained with reference to the exemplary embodiment described below. In this context:

### BRIEF DESCRIPTION OF THE DRAWING

The sole FIGURE shows a perspective view of a battery module in accordance with one exemplary embodiment.

### DETAILED DESCRIPTION OF THE INVENTION

The sole FIGURE depicts a battery module 20 for a motor vehicle, comprising a battery module housing 30 and at least one battery cell package 40, 41. The battery cell package 40, 41 is fitted in a mounting direction M1, M2 into the battery module housing 30 and comprises at least two battery cells which are connected electrically in series. The battery module housing 30 encloses the battery cell package 40, 41 on four sides, and comprises, on at least one of the other two sides, an opening 32 through which the battery cell package 40, 41 is fitted in the mounting direction M1, M2 into the battery module housing 30. The battery module 20 comprises an insertion and positioning aid 60 which serves for inserting the battery cell package 40, 41 in the mounting direction M1, M2 and for positioning the battery cell package 40, 41 in the opening 32 before the insertion of the battery cell package 40, 41 into the battery module housing 30. The insertion and positioning aid 60 comprises at least one runner 62 which extends essentially in the mounting direction M1, M2.

The battery module 20 according to the exemplary embodiment can comprise a total of two battery cell packages 40, 41. The battery cell packages 40, 41 can be arranged one behind the other in the interior of the battery module housing 30.

The battery module housing 30 can comprise a single opening 32, and the battery cell packages 40, 41 can be fitted one after the other and one behind the other into the battery module housing 30 through the same opening 32.

Alternatively, the battery module housing 30 can comprise two openings 32, wherein a first battery cell package 40 is fitted in a first mounting direction M1 into the battery module housing 30 through one of the openings 32, wherein a second battery cell package 41 is fitted into the battery module housing 30 in a second mounting direction

M2 through the other opening 32, and wherein the second mounting direction M2 runs opposite the first mounting direction M1.

The opening 32 or the openings 32 can each be closed off by means of a head plate 50 after the insertion of the battery cell packages 40, 41.

The head plate 50 can be formed from aluminum in the form of an extruded section. The battery module housing 30 can be formed as a single-piece aluminum extruded section. The battery module housing 30 can be embodied with two chambers 34, wherein the chambers 34 can each be separated from one another by a dividing wall 36. In this context, each chamber 34 can accommodate in each case one cell of the battery cell package 40, 41.

The runner 62 can be at a constant distance from the battery module housing 30 over the entire length of said runner 62 in the inserted state of the battery cell packages 40, 41.

The head plate 50 can be connected in a positively locking and/or frictionally locking and/or materially joined fashion to the battery module housing 30, being preferably screwed or welded.

The insertion and positioning aid 60 can comprise at least one component 64 which is arranged at an end 42, to be inserted firstly into the opening 32 in the mounting direction M1, M2, of the battery cell package 40, 41.

The component 64 can have a height which is less than or equal to a height of the opening 32 and/or a width which is less than or equal to a width of the opening 32.

The component 64 can also have a height which is greater than or equal to a height of the battery cell package 40, 41 and/or have a width which is greater than or equal to a width of the battery cell package 40, 41.

The component 64 can comprise an insertion slope and/or a chamfer and/or a radius for centering the battery cell package 40, 41 in the opening 32.

The component 64 can be fabricated at least essentially om plastic.

The battery module 20 can also comprise at least two battery cell packages 40, 41, wherein each of the battery cell packages 40, 41 is provided with the component 64, wherein the component 64 is provided with an electrical high-voltage connecting device which produces an electrical connection to the component 64 of an adjacent battery cell package 40, 41. In this context, the component 64 can protect against inadvertent contact with the high-voltage connecting device.

The runner 62 can be attached to the component 64 and/or to the battery cell package 40, 41. Alternatively, the runner 62 can also run in the interior of the battery module housing 30 and essentially parallel to the mounting direction M1, M2.

The insertion and positioning aid 60 can comprise a groove which extends essentially parallel to the mounting direction and by means of which the runner 62 slides and is guided when the battery cell package 40, 41 is inserted in the mounting direction M1, M2 into the opening 32. If the runner 62 is attached to the component 64 and/or to the battery cell package 40, 41, the groove is arranged in the interior of the battery module housing 30. If the runner 62 is arranged in the interior of the battery module housing 30, the groove can be arranged on the component 64 and/or on the battery cell package 40, 41.

The runner 62 can be fabricated essentially from plastic.

The insertion and positioning aid 60 can comprise at least two runners 62 which are arranged on opposite sides of the battery cell package 40, 41 or on opposite sides of the battery module housing 30. The runners 62 run essentially parallel to the mounting direction M1, M2. In a complementary fashion to this, two grooves which run parallel to the mounting direction M1, M2 can be arranged, said grooves running either in the interior of the battery module housing 30 or along the battery cell package 40, 41. The insertion and positioning aid 60 can comprise at least four runners 62 which are arranged in pairs on opposite sides of the battery cell package 40, 41 or on opposite sides of the battery module housing 30. In a complementary fashion to this, four grooves which run parallel to the mounting direction M1, M2 can be arranged, said grooves running either in the interior of the battery module housing 30 or along the battery cell package 40, 41. In this context, in each case two runners 62 and/or in each case two grooves are arranged is on one side of the battery cell package 40, 41 and/or on one side of the battery module housing 30.

A gap, which is filled with heat-conducting resin or some other heat-conducting medium, can be formed between the battery module housing 30 and the battery cell packages 40, 41 and/or between the individual battery cells of the individual battery cell packages 40, 41.

A battery cell package 40, 41 can be composed, for example from two individual battery cells. These battery cells can be, for example, prismatic battery cells.

The battery module housing 30 can be provided with one or more cooling plates 38, in particular on two opposite closed sides of the battery module housing 30. The cooling plates 38 serve to conduct away the heat which is output by the battery cells.

The insertion and positioning aid 60, in particular the runners 62, the component 64 and/or the grooves can serve to protect the battery cells and/or the electrical high-voltage connecting device when the battery cell packages 40, 41 are inserted into the battery module housing 30. The runners 62 can also serve to brace the battery cell packages 40, 41 in the interior of the battery module housing 30.

By virtue of the battery module 20 in accordance with the application, damage-free fitting of the battery cell packages 40, 41 can be carried out with small tolerance distances. In addition, better package efficiency is achieved. The weight of the battery module 20 and the manufacturing costs are reduced. By virtue of the insertion and positioning aid 60, the gap between the battery cell packages 40, 41 and the battery module housing 30 can be made smaller, as a result of which better conduction away of the heat can take place.

What is claimed is:

1. A battery module for a motor vehicle, said battery module comprising:
a battery module housing;
at least one battery cell package fitted in a mounting direction into the battery module housing and comprising at least two battery cells which are connected electrically in series, wherein the battery module housing encloses the battery cell package on four sides of the battery module housing, and comprises, on at least one of two other sides of the battery module housing, an opening through which the battery cell package is fitted in the mounting direction into the battery module housing,
an insertion and positioning aid which serves for inserting the battery cell package in the mounting direction and for positioning the battery cell package in the opening before the insertion of the battery cell package into the battery module housing, and
at least one runner which extends essentially in the mounting direction.

2. The battery module as claimed in claim 1, wherein the insertion and positioning aid comprises at least one component which is arranged at an end and is configured to be inserted firstly into the opening, in the mounting direction, of the battery cell package.

3. The battery module as claimed in claim 2, wherein the component has at least one of (i) a height which is less than or equal to a height of the opening, and (ii) a width which is less than or equal to a width of the opening.

4. The battery module as claimed in claim 2, wherein the component has at least one of (i) a height which is greater than or equal to a height of the battery cell package, and (ii) a width which is greater than or equal to a width of the battery cell package.

5. The battery module as claimed in claim 2, wherein the component comprises at least one of an insertion slope, a chamfer and a radius for centering the battery cell package in the opening.

6. The battery module as claimed in claim 2, wherein the component comprises plastic.

7. The battery module as claimed in claim 2, further comprising at least two of said battery cell packages, wherein each of the battery cell packages includes one of the components, wherein each component is provided with an electrical high-voltage connecting device which produces an electrical connection to the component of an adjacent battery cell package.

8. The battery module as claimed in claim 2, wherein the runner is attached to the component.

9. The battery module as claimed in claim 1, wherein the insertion and positioning aid comprises a groove which extends substantially parallel to the mounting direction and by way of which the runner slides and is guided when the battery cell package is inserted in the mounting direction into the opening.

10. The battery module as claimed in claim 1, wherein the runner comprises plastic. 11, The battery module as claimed in claim 1, wherein the insertion and positioning aid comprises at least two runners which are arranged on opposite sides of the battery cell package or on opposite sides of the battery module housing. 12, The battery module as claimed in claim 11, wherein the insertion and positioning aid comprises at least four runners which are arranged in pairs either on opposite sides of the battery cell package or on opposite sides of the battery module housing.

13. The battery module as claimed in claim 1, wherein the at least one battery cell package comprises a first battery cell package and a second battery cell package, wherein the battery module housing comprises at least two of the openings,
wherein the first battery cell package is configured to be fitted into the battery module housing in a first mounting direction through one of the two openings, wherein the second battery cell package is configured to be fitted into the battery module housing in a second mounting direction through the other opening, and
wherein the second mounting direction runs opposite the first mounting direction.
